(19) United States
(12) Patent Application Publication
(10) Pub. No.: US 2012/0303246 A1
(43) Pub. Date: Nov. 29, 2012

(54) METHOD FOR OPERATING AN INTERNAL COMBUSTION ENGINE

(76) Inventors: Thomas BECKER, Esslingen/Zell (DE); Michael Mennicken, Wimsheim (DE); Rainer Peck, Ludwigsburg (DE); Andreas Bartsch, Leonberg (DE); Lars Ulrich, Leonberg (DE)

(21) Appl. No.: 13/478,381

(22) Filed: May 23, 2012

(30) Foreign Application Priority Data
May 23, 2011 (DE) 102011076287.6

(51) Int. Cl. F02M 51/00; F02D 41/30

(52) U.S. Cl. 701/104; 701/105

(57) ABSTRACT

A method for operating an internal combustion engine, in which fuel is injected into a combustion chamber of the internal combustion engine with the aid of an injector, a variable which characterizes a slope of a straight line or of a curve which has at least some sections in the shape of a straight line, being ascertained, the straight line or straight line-shaped curve linking activation times of the injector to the appropriate difference values, and a difference value being formed by the difference between an instantaneous closing point in time and a reference closing point in time or between an instantaneous injection quantity and a reference injection quantity, and a measure for a coking of the injector being ascertained from the ascertained variable.

### BACKGROUND INFORMATION

Injecting fuel with the aid of an injector (“common-rail injector”) into a combustion chamber of an internal combustion engine is known from the market. In this process, the injector is subjected to various mechanisms during its lifetime, which—for identical activation, in each case, of an electric actuator which activates the injector—result in changes in the injection fuel quantity. Such mechanisms include, for example, wear of the injector, as well as formation of deposits and coking on a valve needle or a valve nozzle, i.e., outlet opening of the injector.

One patent publication from this technical area is, for example, German Patent No. DE 10 2008 001 412.

### SUMMARY OF THE INVENTION

The method according to the present invention has the advantage that a degree of coking of an injector of an internal combustion engine may be individually ascertained. An injection fuel quantity may thus be correctly metered independently from the degree of coking, thus compensating for the coking. In addition, an instantaneous fuel pressure may be taken into account. By determining the degree of coking, other corrective functions of the internal combustion engine may also work more accurately. For example, the exhaust gas emissions and the running smoothness over the lifetime of the injector may be set or regulated essentially independently from the degree of coking. Possible damage to the internal combustion engine may be prevented. It is furthermore possible to ascertain the degree of coking of the injector independently of other variables influencing the operation of the injector, such as wear of a valve seat of the injector or formation of deposits on a valve needle. In certain cases, it may be possible to determine whether or not a non-regeneratable injector defect has occurred.

Coking affects the fuel quantity injected by the injector, in particular during medium-long or long activation times, which changes an injected actual fuel quantity with respect to a setpoint fuel quantity to be injected. Coking may affect, in particular, a valve nozzle (injector nozzle), i.e., outlet opening of the injector. The degree of coking, which characterizes coking, may increase or also decrease during the lifetime of the injector due to operating conditions of the injectors, for example, and is thus variable over time.

Coking of the injector, in particular in the area of the injector nozzle, i.e., the outlet opening of the injector, may result in a change in the particular pressure differences (back pressure) and thus in a decrease in the fuel quantity flowing through. For example, the dynamics of the injector may be modified in that the valve needle is accelerated more during the opening motion as a result of coking, which may result in a delayed closing point in time.

First, reference closing points in time of the injector are ascertained according to the present invention as a function of activation times of the injector, for example on a test bench for a new injector, and stored. Second, in a similar manner, instantaneous closing points in time of the injector are ascertained during the continued operation of the internal combustion engine. “Activation” of the injector is understood here as the activation of one of the electric actuators that activate the injector and are installed in a housing together with the injector, for example.

Furthermore, differences between the particular instantaneous closing points in time and the particular reference closing points in time are formed, resulting in corresponding difference values. The difference values thus obtained are linked to the associated activation times to form a functional relationship in the form of a (mathematical) curve. The curve essentially has the shape of a straight line, or at least some sections of it have the shape of a straight line. A variable which characterizes a slope of the straight lines or of a straight-line section of the curve is ascertained from the curve. At least two different activation times are therefore needed for ascertaining the curve or its slope. According to the present invention, the variable, i.e., the slope, is used for ascertaining a measure of coking of the injector (degree of coking).

Alternatively to the reference closing point in time or the instantaneous closing point in time, according to the present invention a reference injection quantity or an instantaneous injection quantity of the fuel may also be used. These are used in a comparable manner as a function of the activation time for ascertaining the degree of coking, as described above.

In particular, it is provided that, as mentioned previously, the reference closing point in time or the reference injection quantity was ascertained on an uncoked reference injector and stored in a memory. The associated activation times and the particular fuel pressure were also stored. This allows the stored values to be repeatedly accessed during ongoing operation of the internal combustion engine and used for ascertaining the degree of coking. This may simplify the procedure.

The reference injector may be a separate component, for example in a measuring assembly of a manufacturing unit. The reference injector may also be the particular injector installed in the internal combustion engine, which is measured in a new state of the injector, i.e., of the internal combustion engine, by the same devices also used for ascertaining the instantaneous closing points in time or the instantaneous injection fuel quantities during continued operation.

The accuracy of the method is increased if it is performed at a constant fuel pressure. This allows the curves which are linear at least in some sections to be ascertained particularly accurately using multiple activation times of different lengths. The particular fuel pressure may be stored together with the reference closing points in time or reference injection quantities as parameters. The instantaneous closing points in time or the instantaneous injection quantities are also ascertained at a constant fuel pressure, so that a particularly accurate comparison with the particular reference values is possible. In addition, a fuel temperature and/or a fuel type may also be taken into account in an appropriate manner.

It is furthermore provided that a variable which corresponds to a greater slope is evaluated as an indication of more intensive coking than a variable which corresponds to a lesser slope. This relationship is monotonous in general. The extent of coking may thus be ascertained quantitatively and relatively accurately. Of course, depending on a selected algebraic sign of the difference values, “greater slope” may also mean a “greater absolute value of the slope.”

The method according to the present invention is useful in particular if the activation of the injector is changed as a function of the ascertained degree of coking in such a way that an actual injection quantity of the fuel is corrected with respect to a setpoint injection quantity. The operating characteristics of the internal combustion engine, in particular the power output, the exhaust gas emissions and the running smoothness, are thus essentially independent of the particular degree of coking over the lifetime of the injector.

One embodiment of the method provides that the closing point in time is ascertained in that a striking of a valve element on the valve seat of the injector is ascertained by evaluating an electrical signal applied to an electric actuator of the injector. The electrical signal is preferably detected at the same terminals used for activating the injector. In general, the electrical signal characterizing the closing point in time appears after a certain delay after an activation voltage has been switched off. The closing point in time may be ascertained in a particularly simple and accurate manner by evaluating the electrical signal.

One embodiment of the present invention provides that, when it is determined that coking exists, an appropriate input is made into a memory that is readable by a diagnostic device. This advantageously improves the diagnosis of the internal combustion engine.

The method according to the present invention is preferably carried out with the aid of a computer program, which is programmed according to the particular method steps. The computer program runs, for example, on a control and/or regulating unit, which controls a fuel system of the internal combustion engine.

### BRIEF DESCRIPTION OF THE DRAWINGS

FIG. 1 shows a simplified diagram of an internal combustion engine.

FIG. 2 shows a simplified sectional view of an injector.

FIG. 3 shows a family of curves together with closing points in time over an activation period.

FIG. 4 shows a family of curves together with injection fuel quantities over an activation period.

FIG. 5 shows a flow chart for carrying out the method.

### DETAILED DESCRIPTION

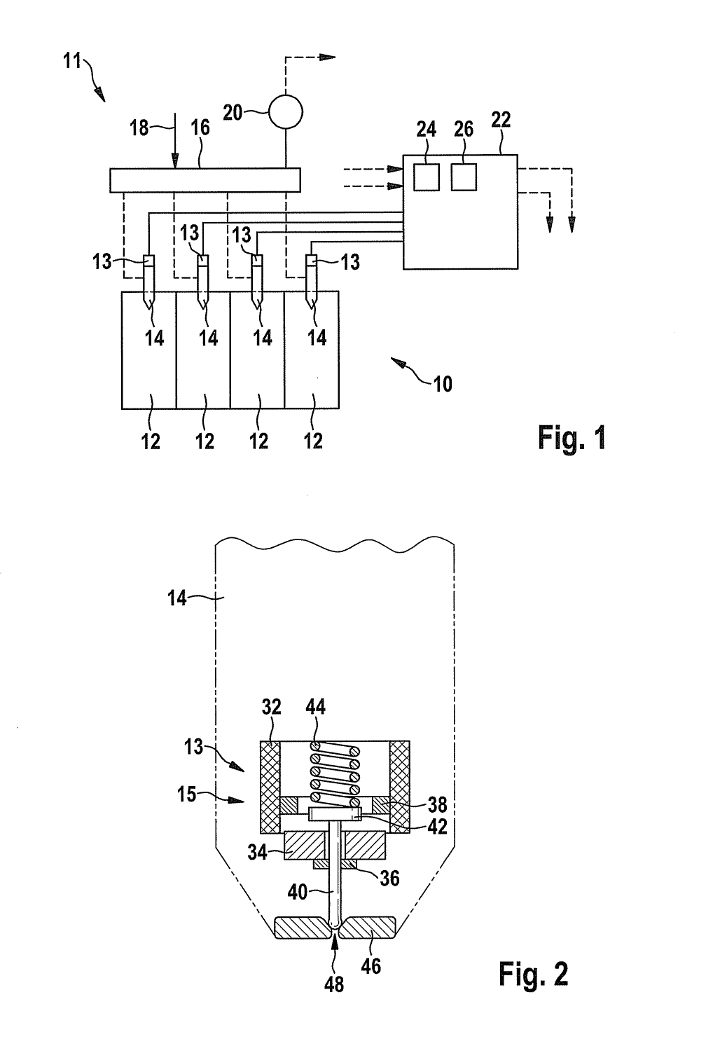

FIG. 1 shows a simplified diagram of a fuel system 11 of an internal combustion engine 10, here having four cylinders 12 and corresponding injectors 14 for injecting fuel. Injectors 14 may be activated by one electric actuator 13 each. Above injectors 14, a high-pressure accumulator 16 is shown, which is supplied with fuel from a high-pressure line 18 and monitored by a pressure sensor 20. Internal combustion engine 10 is designed either as a gasoline engine or as a diesel engine. In the upper right part of FIG. 1, a control and/or regulating unit 22 is shown, together with indicated outgoing and incoming control lines, as well as an electric memory 24 and a computer program 26 situated therein.

During operation, a fuel pump (not illustrated) supplies high-pressure accumulator 16 via high-pressure line 18, pressure sensor 20 reporting the instantaneous fuel pressure to control and/or regulating unit 22 via an indicated signal line. The four injectors 14 supply a certain fuel quantity into cylinders 12 as a function of an activation signal of electric actuator 13.

FIG. 2 schematically shows some elements of an injector 14 for direct fuel injection of an internal combustion engine 10. Injector 14 is shown closed in FIG. 2. Electric actuator 13, which is an electromagnet here, is illustrated, among other things. Electric actuator 13 includes an armature winding 32 and an armature 34, which is drawn into armature winding 32 when energized. The movement of armature 34 is delimited by a rest seat 36 and by an armature stop 38. When injector 14 is closed, armature 34 rests on rest seat 36. A valve needle 40, whose upper end on the drawing is fixedly connected to a disk-shaped plate 42, is directed through an axial bore hole in armature 34. A helical spring 44 acts upon plate 42 and thus presses valve needle 40 in the closing direction. Valve needle 40 and plate 42 together form a valve element 15.

A valve seat 46 is situated on the lower end of injector 14 in the drawing. An outlet opening 48 is closed when valve needle 40 rests on valve seat 46, and is opened when valve needle 40 is lifted (not shown). Other elements of injector 14, such as fuel channels, are not shown. All movements take place in the vertical direction with respect to FIG. 2.

It is understood that injector 14 may also be designed as a so-called servo-valve, and the method according to the present invention may be carried out therewith. This, however, is not shown in FIG. 2. The actuator may also be a piezoelectric element, which is also not shown in FIG. 2.

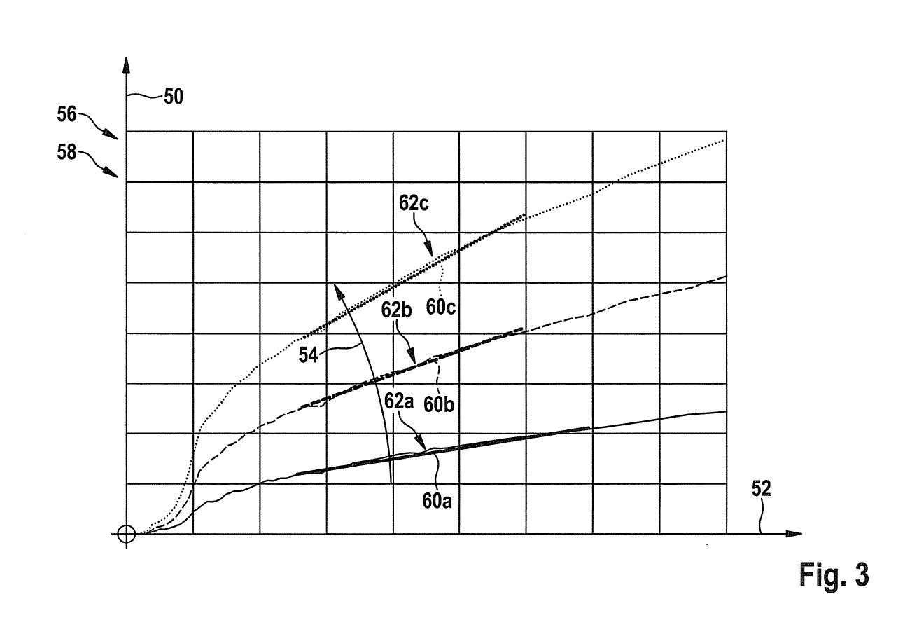

FIG. 3 shows a first family of curves, which describes a difference value 50 as a function of an activation time 52. The parameter of the three curves illustrated in the drawing is the particular measure 54 of coking (degree of coking) of injector 14. Coking means deposits in an area of an injector nozzle, i.e., of outlet opening 48 of injector 14, which form or are promoted, in particular, by unsuitable fuels and/or high temperatures. For example, coking may cause a decrease in the hydraulic flow through the injector nozzle.

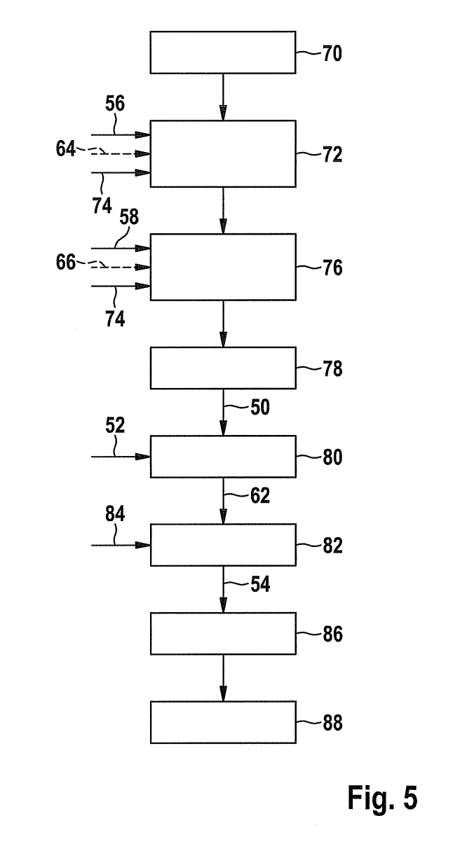

Difference values 50 of FIG. 3 are formed by a difference between instantaneous closing points in time 56 (see FIG. 5) and reference closing points in time 58 (see FIG. 5). In the drawing, the arrow describing measure 54 points toward higher degrees of coking. A zero degree of coking corresponds to the abscissa of the coordinate system shown, since here the difference between instantaneous closing points in time 56 and reference closing points in time 58 is zero for any activation time 52; therefore, difference values 50 are also zero.

It is apparent that in a central area of the drawing, a straight line 60 may be specified for each of the three curves shown, here labeled as straight lines 60a, 60b, and 60c, for which some sections of the particular curves approximately have the shape of a straight line. It is furthermore apparent that difference value 50 increases as a function of measure 54 with increasing activation time 52. Accordingly, associated slopes 62a, 62b, and 62c also increase. It results herefrom that slopes 62a, 62b, and 62c are suitable for providing measure 54 of coking.

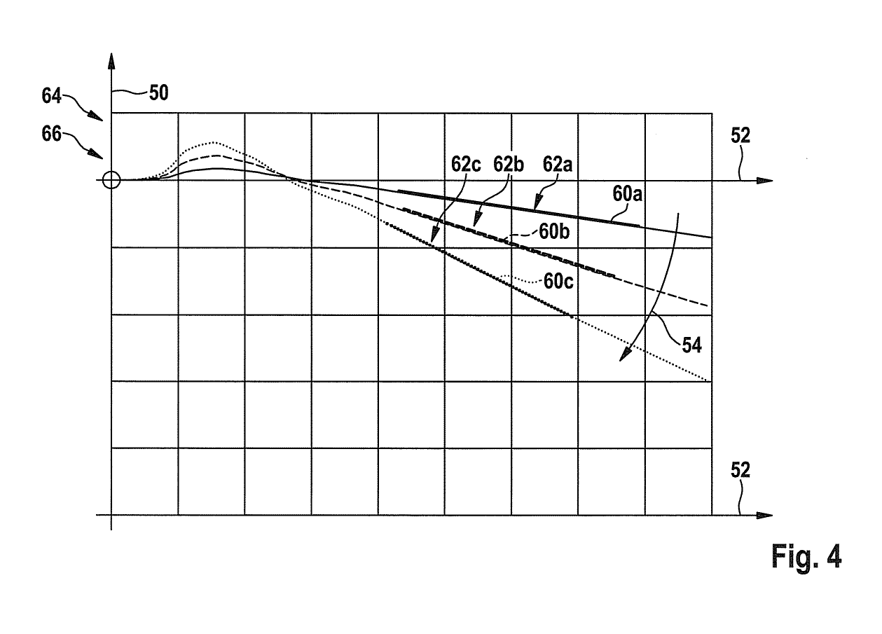

FIG. 4 shows a second family of curves, which describes a difference value 50 as a function of activation time 52. As in FIG. 3, the parameter of the family of curves is measure 54 of coking. Unlike in FIG. 3, the abscissa is situated in the upper area of the coordinate system, and measure 54 of coking becomes greater downward in the drawing. Difference values 50 of FIG. 4 are formed by a difference between instantaneous injection quantities 64 (see FIG. 5) and reference injection quantities 66 (see FIG. 5). The injection quantity of fuel decreases with the increasing degree of coking.

As in FIG. 3, in FIG. 4, a straight line 60, here labeled as straight lines 60a, 60b, and 60c, may be specified for each of the three curves shown, for which some sections of the particular curve approximately have the shape of a straight line. It is apparent that slope 62 decreases with increasing measure 54 of coking (or the absolute value of slope 62 increases). Accordingly, slopes 62a through 62c (or their absolute values) characterize the particular measure 54 of coking.

FIG. 5 shows a simple flow chart of the sequence of computer program 26 on control and/or regulating unit 22 of internal combustion engine 10. The flow chart is essentially executed from the top down in the drawing.

Starting at a start block 70, in a block 72, at least two instantaneous closing points in time 56 or instantaneous injection quantities 64 of injector 14 are ascertained for different activation times 52. An instantaneously prevailing fuel pressure 74 is also detected. However, in block 72 preferably more than two ascertainments are performed each time using different activation times 52 and at a constant fuel pressure 74.

In a subsequent block 76, two or more reference closing points in time 58 or reference injection quantities 66 are read from memory 24 of control and/or regulating unit 22. Reference closing points in time 58 or reference injection quantities 66 were ascertained on an uncoked reference injector 14 or on a new injector 14 for comparable activation times 52 and at a fuel pressure 74 comparable to that of the instantaneous ascertainments.

In a subsequent block 78, a difference between the particular instantaneous closing points in time 56 and the particular reference closing points in time 58 or the particular instantaneous injection quantities 64 and the particular reference injection quantities 66 is formed. Particular difference values 50 are obtained as a result.

In a subsequent block 80, difference values 50 are brought into a functional relationship with associated activation times 52 in the form of a mathematical curve. Then, slope 62 of the curve, or at least of a curve section in the shape of a straight line, is ascertained.

In a subsequent block 82, ascertained slope 62 is compared with a comparison value 84 read from memory 24. Comparison value 84 is parameterized with fuel pressure 74 and measure 54 of coking. Measure 54 may be ascertained therefrom as a numerical value, for example, as a percentage.

In a subsequent block 86, steps are executed, with the aid of which an actual injection quantity of fuel, i.e., the prevailing instantaneous injection quantity 64, is corrected with respect to a setpoint injection quantity. The effect of coking is thus compensated for. In the case of a measure 54 of coking which exceeds a threshold value, an appropriate input is made at the same time into a memory that is readable by a diagnostic device.

In a subsequent end block 88 the procedure illustrated in FIG. 5 is terminated. The program execution may be returned to a main program or, as an alternative, the procedure described in FIG. 5 may be repeated.

What is claimed is:

1. A method for operating an internal combustion engine, in which fuel is injected into a combustion chamber of the internal combustion engine with the aid of an injector, the method comprising:
ascertaining a variable, which characterizes a slope of a straight line or of a curve which has at least some sections in the shape of a straight line, the straight line or straight line-shaped curve linking activation times of the injector to associated difference values;
forming a difference value by a difference between an instantaneous closing point in time and a reference closing point in time or between an instantaneous injection quantity and a reference injection quantity; and
ascertaining a measure for a coking of the injector from the ascertained variable.

2. The method according to claim 1, wherein the reference closing point in time or the reference injection quantity is ascertained on an uncoked reference injector and is stored in a memory.

3. The method according to claim 1, wherein the steps are carried out at a constant fuel pressure.

4. The method according to claim 1, wherein a variable which corresponds to a greater slope is evaluated as an indication of more intensive coking than a variable which corresponds to a lesser slope.

5. The method according to claim 1, wherein an activation of the injector is changed as a function of the ascertained coking in such a way that an actual injection quantity of fuel is corrected with respect to a setpoint injection quantity of fuel.

6. The method according to claim 1, wherein the closing point in time is ascertained in that striking of a valve element on a valve seat of the injector is ascertained by evaluating an electrical signal applied to an electric actuator of the injector.

7. The method according to claim 1, wherein, when it is determined that coking exists, an input is made into a memory which is readable by a diagnostic device.

8. A non-transitory computer-readable medium containing a program which when executed by a processor performs the following method for operating an internal combustion engine, in which fuel is injected into a combustion chamber of the internal combustion engine with the aid of an injector:
ascertaining a variable, which characterizes a slope of a straight line or of a curve which has at least some sections in the shape of a straight line, the straight line or straight line-shaped curve linking activation times of the injector to associated difference values;
forming a difference value by a difference between an instantaneous closing point in time and a reference closing point in time or between an instantaneous injection quantity and a reference injection quantity; and
ascertaining a measure for a coking of the injector from the ascertained variable.

9. A control/regulating unit for an internal combustion engine, in which fuel is injected into a combustion chamber of the internal combustion engine with the aid of an injector, the unit comprising:
an arrangement for ascertaining a variable, which characterizes a slope of a straight line or of a curve which has at least some sections in the shape of a straight line, the straight line or straight line-shaped curve linking activation times of the injector to associated difference values;
an arrangement for forming a difference value by a difference between an instantaneous closing point in time and a reference closing point in time or between an instantaneous injection quantity and a reference injection quantity; and
an arrangement for ascertaining a measure for a coking of the injector from the ascertained variable.
